(19) United States
(12) Patent Application Publication
(10) Pub. No.: US 2016/0121933 A1
(43) Pub. Date: May 5, 2016

(54) VEHICLE STRUCTURE

(71) Applicant: TOYOTA JIDOSHA KABUSHIKI KAISHA, Toyota-shi (JP)

(72) Inventor: Yukito OHMURA, Nagoya-shi (JP)

(73) Assignee: TOYOTA JIDOSHA KABUSHIKI KAISHA, Toyota-shi (JP)

(21) Appl. No.: 14/921,200

(22) Filed: Oct. 23, 2015

(30) Foreign Application Priority Data
Nov. 4, 2014 (JP) 2014-224485

(51) Int. Cl. B62D 21/15; B60K 5/04; B62D 25/08

(52) U.S. Cl. CPC B62D 21/152; B62D 25/085; B60K 5/04

(57) ABSTRACT

An engine unit 32 is held, by an engine-side holder 42 disposed on a side member 22 on the engine unit 32 side, on the side member 22. A transmission unit 34 is held, by a transmission-side holder 44 disposed on a side member 24 on the transmission unit 34 side, on the side member 24. A unit arresting member 50 is disposed on the side member 22 on the vehicle front and rear direction rear side of the engine-side holder 42. A unit arresting member 50 is disposed on the side member 24 on the vehicle front and rear direction rear side of the transmission-side holder 44. Unit-side opposing surfaces 52 on distal ends of the unit arresting members 50 are placed opposing an engine-side opposing surface 36 and a transmission-side opposing surface 38.

### CROSS-REFERENCE TO RELATED APPLICATION

This application is based on and claims priority under 35 USC 119 from Japanese Patent Application No. 2014-224485 filed on Nov. 4, 2014, the disclosure of which is incorporated by reference herein.

### BACKGROUND

1. Technical Field

The present invention relates to a vehicle structure.

2. Related Art

Japanese Patent Application Laid-open (JP-A) No. 2009-234279 discloses a vehicle front portion structure equipped with a pair of side members and a rearward movement regulating member that catches a rear side end portion of a transmission unit, with the rearward movement regulating member being integrally disposed on the side member on the side where the transmission unit is disposed (see JP-A No. 2009-234279).

Here, in a structure where an engine unit (a drive source) and a transmission unit (a transmission) are placed adjacent to each other in the vehicle width direction between a pair of right and left side members, there are cases where, when the vehicle crashes into a pole, the rear end portions of the engine unit and the transmission unit move rearward in the vehicle front and rear direction while rotating in directions away from each other.

There is the concern that this rotation of the engine unit and the transmission unit cannot be sufficiently checked by the rearward movement regulating member that catches the rear side end portion of the transmission unit of JP-A No. 2009-234279.

Another related technology is disclosed in JP-A No. 2010-83261.

### SUMMARY OF THE INVENTION

In view of the circumstances described above, it is an object of the present invention to obtain a vehicle structure which, when the vehicle crashes into a pole, can check the rotation of a drive source and a transmission placed adjacent to each other in the vehicle width direction between a pair of right and left side members.

A vehicle structure of a first aspect of the present invention includes: a pair of right and left side members that are disposed along a vehicle front and rear direction at both side portions in a vehicle width direction; a drive source and a transmission that are placed adjacent to each other in the vehicle width direction between the pair of right and left side members; a drive source-side holder that is disposed at a side member on a drive source side and holds the drive source; a transmission-side holder that is disposed at a side member on a transmission side and holds the transmission; a drive source-side projecting portion that is disposed at the side member on the drive source side on a vehicle front and rear direction central side of the drive source-side holder, projects toward a drive source-side opposing surface disposed on a vehicle width direction outer side of the drive source, and has formed on its distal end a projecting portion-side opposing surface that opposes or touches the drive source-side opposing surface; and a transmission-side projecting portion that is disposed at the side member on the transmission side on the vehicle front and rear direction central side of the transmission-side holder, projects toward a transmission-side opposing surface disposed on the vehicle width direction outer side of the transmission, and has formed on its distal end a projecting portion-side opposing surface that opposes or touches the transmission-side opposing surface.

In the vehicle structure of the first aspect, when the vehicle crashes into a pole (in a case where the vehicle is involved in a frontal crash or a rear-end crash with a pole-like crash object), the side of the drive source on the vehicle front and rear direction central side (the vehicle front and rear direction rear side or front side) of the drive source-side holder and the side of the transmission on the vehicle front and rear direction central side (the vehicle front and rear direction rear side or front side) of the transmission-side holder try to rotate away from each other in the vehicle width direction.

However, the drive source-side opposing surface disposed on the vehicle width direction outer side of the drive source and the transmission-side opposing surface disposed on the vehicle width direction outer side of the transmission come into contact with the projecting portion-side opposing surfaces of the drive source-side projecting portion and the transmission-side projecting portion disposed on the side members, and thus the rotation of the drive source and the transmission is checked.

A vehicle structure of a second aspect of the present invention is the structure of the first aspect, wherein a vehicle up and down direction width of the projecting portion-side opposing surfaces of the drive source-side projecting portion and the transmission-side projecting portion is set wider than a vehicle up and down direction width of side surfaces on a vehicle width direction inner sides of the side members.

In the vehicle structure of the second aspect, the vehicle up and down direction width of the projecting portion-side opposing surfaces of the drive source-side projecting portion and the transmission-side projecting portion is wider than the vehicle up and down direction width of the side surfaces on the vehicle width direction inner sides of the side members. Thus, the load of the drive source or the transmission is received by the projecting portion-side opposing surfaces that have a wide area, and the loads received by the drive source-side projecting portion and the transmission-side projecting portion are received and stopped in the wide ranges of the side surfaces of the side members. Consequently, the effect of checking the rotation of the drive source and the transmission when the vehicle crashes into a pole is improved.

According to the invention of the first aspect, when the vehicle crashes into a pole, the rotation of the drive source and the transmission placed adjacent to each other in the vehicle width direction between the pair of right and left side members can be checked.

According to the invention of the second aspect, the rotation of the drive source and the transmission can be checked even more.

### BRIEF DESCRIPTION OF THE DRAWINGS

FIG. 1 is a plan view schematically showing a front portion of a vehicle to which a vehicle structure of an embodiment of the present invention has been applied;

FIG. 2A is an exploded perspective view before attaching a unit arresting member to a side member;

FIG. 2B is a perspective view of the unit arresting member;

FIG. 3 is a longitudinal sectional view along line 3-3 of FIG. 1;

FIG. 4A is a plan view just before the vehicle of FIG. 1 is involved in a frontal crash with a pole-like crash object P;

FIG. 4B is a plan view just after the vehicle of FIG. 1 is involved in a frontal crash with the pole-like crash object P;

FIG. 5A is a plan view just before a vehicle of a comparative example is involved in a frontal crash with a pole-like crash object P; and

FIG. 5B is a plan view just after the vehicle of the comparative example is involved in a frontal crash with the pole-like crash object P.

### DETAILED DESCRIPTION OF THE INVENTION

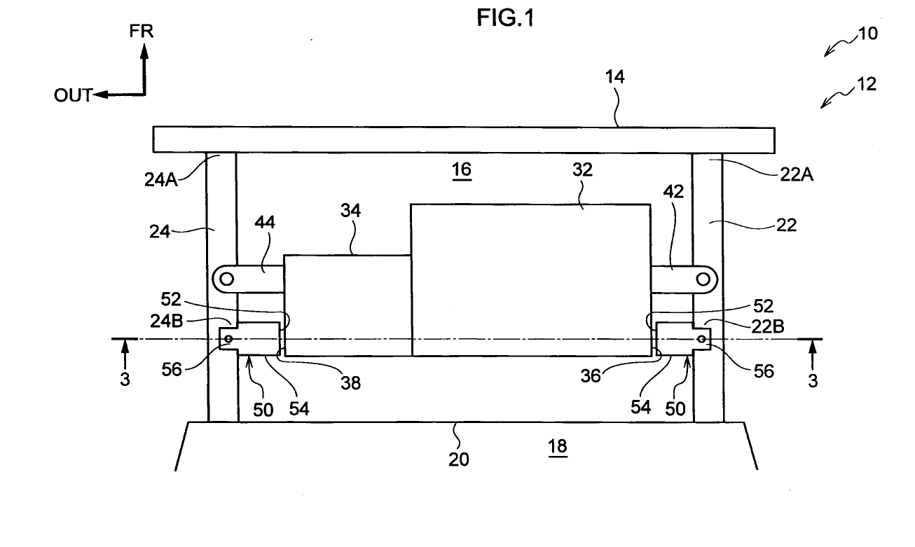

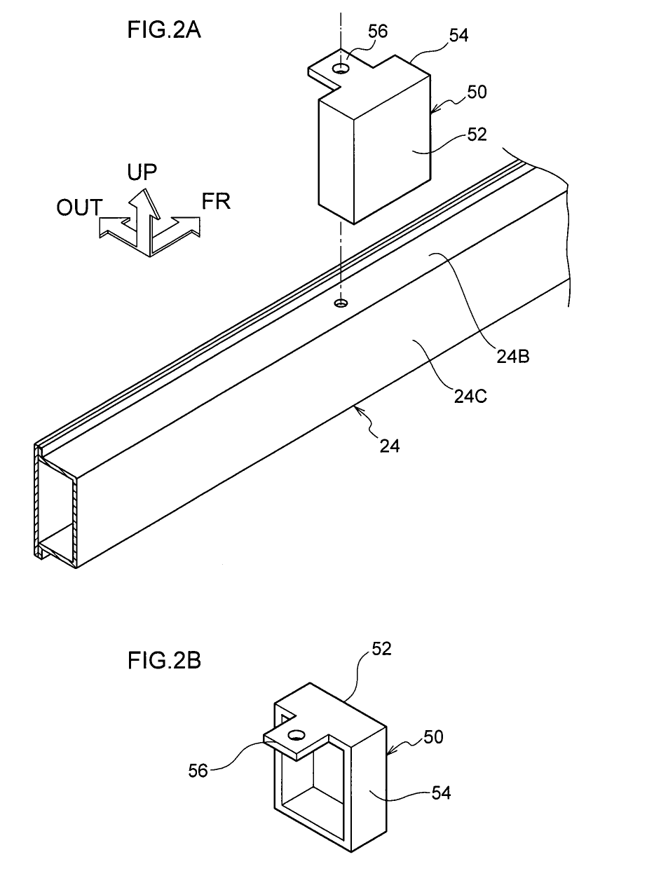

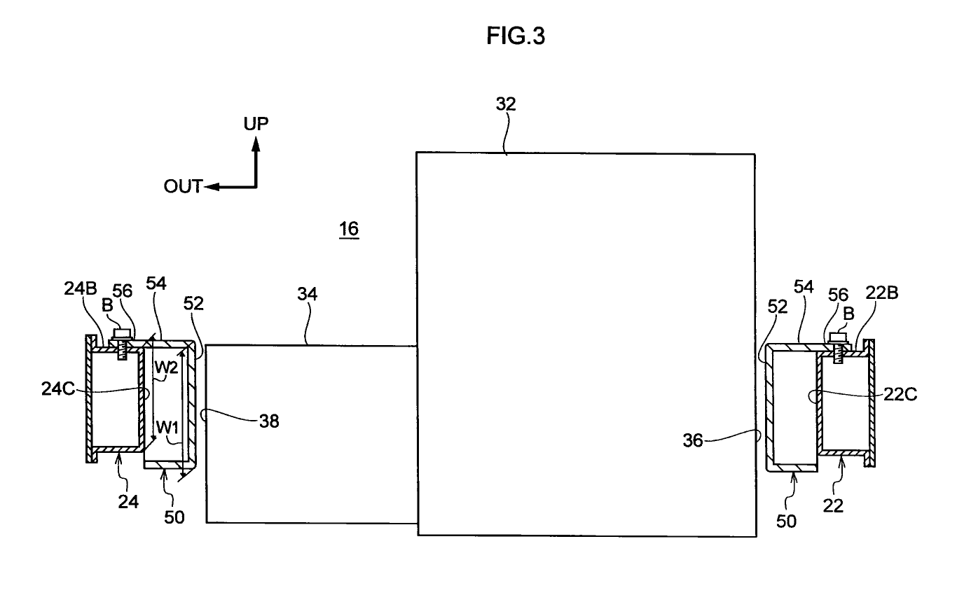

A vehicle structure pertaining to an embodiment of the present invention will now be described using FIG. 1 to FIG. 5B. It should be noted that, in the drawings, arrow FR indicates a forward direction in the vehicle front and rear direction, arrow OUT indicates an outward direction in the vehicle width direction, and arrow UP indicates an upward direction in the vehicle up and down direction. However, FIG. 2B shows no arrows because it is a stand-alone perspective view of a unit arresting member 50 described later. Furthermore, although FIG. 3 is a sectional view, hatching indicating cross sections of an engine unit 32 and a transmission unit 34 described later is omitted.

<Structure>

FIG. 1 shows a front portion 12 of a front-engine, front-wheel-drive vehicle 10 to which the vehicle structure pertaining to the embodiment of the present invention has been applied. As shown in FIG. 1, a bumper reinforcement 14 placed in such a way that its lengthwise direction coincides with the vehicle width direction is disposed on the front end portion of the vehicle 10. A non-illustrated absorber (cushioning material) comprising foam, for example, is attached to the front surface of the bumper reinforcement 14, and the absorber and the bumper reinforcement 14 are covered by a non-illustrated bumper cover.

A pair of right and left side members 22 and 24 whose cross sections have a closed cross-sectional structure are disposed along the vehicle front and rear direction in both side portions in the vehicle width direction of the front portion 12 of the vehicle 10 (see also FIG. 2A and FIG. 3). Front end portions 22A and 24A of the pair of right and left side members 22 and 24 are joined to rear surfaces of both vehicle width direction end portions (both lengthwise direction end portions) of the bumper reinforcement 14. It should be noted that crash boxes are not disposed between the bumper reinforcement 14 and the front end portions 22A and 24A of the side members 22 and 24.

An engine unit 32 serving as an example of a drive source and a transmission unit 34 serving as an example of a transmission are placed adjacent to each other in the vehicle width direction in an engine compartment 16 between the side member 22 and the side member 24 (see also FIG. 3). Furthermore, a dash panel 20 that partitions the engine compartment 16 and a cabin 18 from each other is disposed on the vehicle front and rear direction rear side of the engine unit 32 and the transmission unit 34.

The engine unit 32 is held, by an engine-side holder 42 disposed on the side member 22 on the engine unit 32 side (the right side in FIG. 1), on the side member 22. Likewise, the transmission unit 34 is held, by a transmission-side holder 44 disposed on the side member 24 on the transmission unit 34 side (the left side in FIG. 1), on the side member 24.

A unit arresting member 50 is disposed on the side member 22 on the vehicle front and rear direction rear side of the engine-side holder 42. The unit arresting member 50 projects toward an engine-side opposing surface 36 disposed on the vehicle width direction outer side of the engine unit 32 on the vehicle front and rear direction rear side (the cabin 18 side) of the engine-side holder 42. A unit-side opposing surface 52 is formed on the distal end of the unit arresting member 50. The unit-side opposing surface 52 is spaced apart from and placed opposing the engine-side opposing surface 36 (see also FIG. 3).

Likewise, a unit arresting member 50 is disposed on the side member 24 on the vehicle front and rear direction rear side of the transmission-side holder 44. The unit arresting member 50 projects toward a transmission-side opposing surface 38 disposed on the vehicle width direction outer side of the transmission unit 34 on the vehicle front and rear direction rear side (the cabin 18 side) of the transmission-side holder 44. A unit-side opposing surface 52 is formed on the distal end of the unit arresting member 50. The unit-side opposing surface 52 is spaced apart from and placed opposing the transmission-side opposing surface 38 (see also FIG. 3).

As shown in FIG. 1 and FIG. 3, in the present embodiment, the unit-side opposing surfaces 52 of the unit arresting members 50 are flat and are placed in proximity to the engine-side opposing surface 36 and the transmission-side opposing surface 38 that are likewise flat.

Next, the unit arresting members 50 will be described. In the present embodiment, the unit arresting members 50 have the same structure on the engine unit 32 side and the transmission unit 34 side, so they will be described without distinguishing between them.

As shown in FIG. 2A, FIG. 2B, and FIG. 3, each of the unit arresting members 50 has a box-like body portion 54, which is placed in such a way that its open side faces outward in the vehicle width direction, and an attachment portion 56, which extends outward in the vehicle width direction from the upper end portion of the body portion 54. Additionally, the attachment portions 56 are fastened by bolts B to upper surface portions 22B and 24B of the side members 22 and 24.

Furthermore, as shown in FIG. 3, in a state in which the attachment portions 56 of the unit arresting members 50 have been fastened by the bolts to the upper surface portions 22B and 24B of the side members 22 and 24, the side surfaces on the vehicle width direction inner sides of the body portions 54 (the bottom surfaces of the boxes) configure the unit-side opposing surfaces 52 that oppose (are in proximity to) the engine-side opposing surface 36 and the transmission-side opposing surface 38.

Furthermore, as shown in FIG. 3, a vehicle up and down direction width W1 of the unit-side opposing surfaces 52 of the unit arresting members 50 is set wider than a vehicle up and down direction width W2 of side surfaces 22C and 24C on the vehicle width direction inner sides of the side members 22 and 24.

<Action and Effects>

Next, the action and effects of the present embodiment will be described.

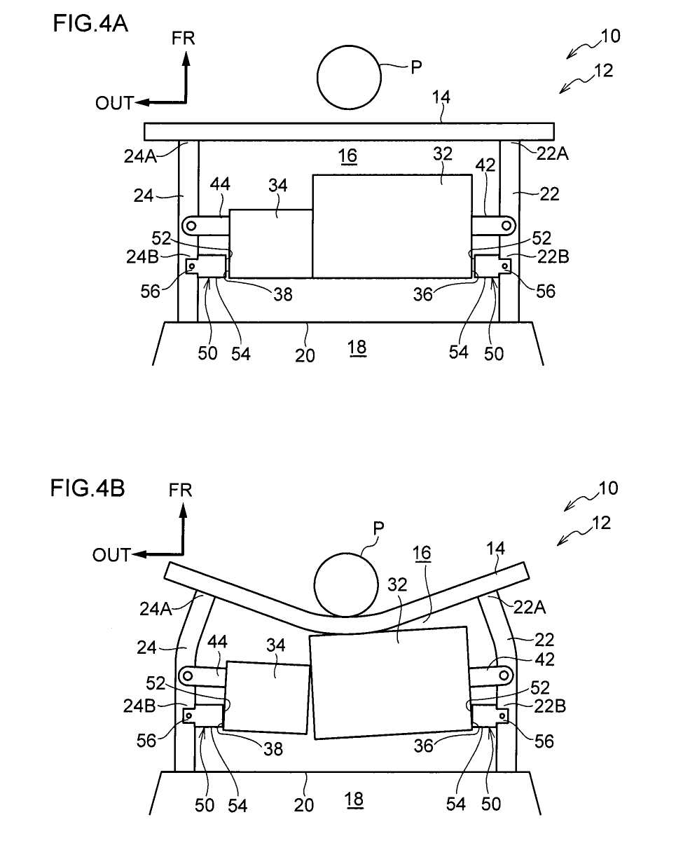

As shown in FIG. 4A and FIG. 4B, in a case where the vehicle 10 is involved in a frontal crash with a pole-like crash object P (when the vehicle crashes into a pole), the engine unit 32 and the transmission unit 34 separate from each other and their sides on the vehicle front and rear direction rear sides of the engine-side holder 42 and the transmission-side holder 44 try to rotate in directions away from each other in the vehicle width direction.

However, as shown in FIG. 4B, just after the separation the engine-side opposing surface 36 of the engine unit 32 and the transmission-side opposing surface 38 of the transmission unit 34 come into contact with the unit-side opposing surfaces 52 of the unit arresting members 50 disposed on the side members 22 and 24. Because of this, the rotation of the engine unit 32 and the transmission unit 34 in directions away from each other is stopped or checked.

Furthermore, as shown in FIG. 3, the vehicle up and down direction width W1 of the unit-side opposing surfaces 52 of the unit arresting members 50 is wider than the vehicle up and down direction width W2 of the side surfaces 22C and 24C on the vehicle width direction inner sides of the side members 22 and 24. Thus, the load of the engine unit 32 or the transmission unit 34 is received by the unit-side opposing surfaces 52 that have a relatively wide area and a wide width, and the loads received by the unit arresting members 50 are received and stopped in the wide ranges of the side surfaces 22C and 24C of the side members 22 and 24. Consequently, the rotation checking effect that the unit arresting members 50 have on the engine unit 32 and the transmission unit 34 is improved.

Furthermore, because the rotation of the engine unit 32 and the transmission unit 34 is stopped or checked by the unit arresting members 50 in this way, as shown in FIG. 4B, the bending deformation of the front end portions 22A and 24A of the side members 22 and 24 inward in the vehicle width direction is checked. Consequently, the intrusion of the crash object P into the front portion 12 of the vehicle 10 is checked (the amount of intrusion is small).

Thus, in a case where the vehicle 10 is involved in a frontal crash with the pole-like crash object P as shown in FIG. 4A and FIG. 4B, it is difficult for the engine unit 32 and the transmission unit 34 to move as far as the dash panel 20, or, even if the engine unit 32 and the transmission unit 34 do move, the loads are received in the wide range of the dash panel 20 and deformation of the dash panel 20 is checked because the rotation of the engine unit 32 and the transmission unit 34 is checked.

Furthermore, in the present embodiment, the unit-side opposing surfaces 52 of the right and left unit arresting members 50 are spaced apart from, and do not touch, the engine-side opposing surface 36 of the engine unit 32 and the transmission-side opposing surface 38 of the transmission unit 34. Thus, the vibration of the engine unit 32 and the transmission unit 34 is not transmitted via the unit arresting members 50 to the side members 22 and 24.

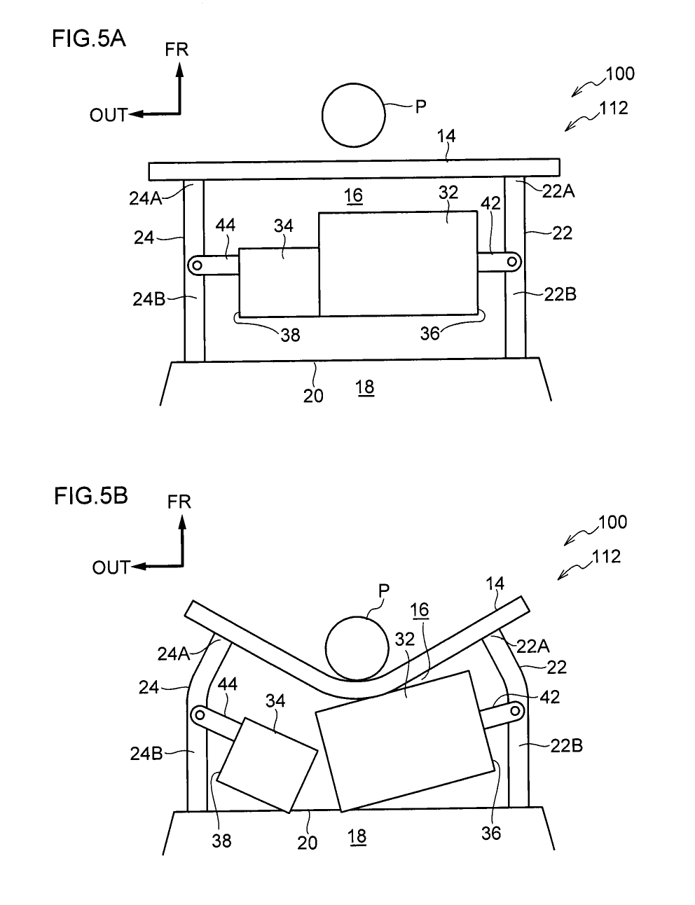

Here, FIG. 5A and FIG. 5B show a front portion 112 of a vehicle 100 of a comparative example in which the unit arresting members 50 are not disposed.

As shown in FIG. 5A and FIG. 5B, in a case where the vehicle 100 of the comparative example is involved in a frontal crash with a pole-like crash object P, the engine unit 32 and the transmission unit 34 separate from each other, and their sides on the vehicle front and rear direction rear side of the engine-side holder 42 and the transmission-side holder 44 rotate in directions away from each other in the vehicle width direction. Furthermore, the front end portions 22A and 24A of the side members 22 and 24 become bent and deformed inward in the vehicle width direction, and the crash object P intrudes to a large extent into the front portion 112 of the vehicle 100 (the amount of intrusion is large).

Thus, in a case where the vehicle 100 of the comparative example is involved in a frontal crash with the pole-like crash object P, it is easy for the engine unit 32 and the transmission unit 34 to move as far as the dash panel 20. Additionally, due to the rotation of the engine unit 32 and the transmission unit 34, loads are locally input to the dash panel 20 and it is easy for the dash panel 20 to become deformed to a large extent.

In contrast, in the vehicle 10 of the present embodiment, as mentioned above, the rotation of the vehicle front and rear direction rear sides of the engine unit 32 and the transmission unit 34 in directions away from each other in the vehicle width direction is checked by the unit arresting members 50, and bending deformation of the front end portions 22A and 24A of the side members 22 and 24 inward in the vehicle width direction is checked.

Thus, it is difficult for the engine unit 32 and the transmission unit 34 to move as far as the dash panel 20. Furthermore, even if the engine unit 32 and the transmission unit 34 do move, the loads are input to the wide range of the dash panel 20 and deformation of the dash panel 20 is checked because the rotation of the engine unit 32 and the transmission unit 34 is checked.

### Other Embodiments

It should be noted that the present invention is not limited to the above embodiment.

In the above embodiment, the unit-side opposing surfaces 52 of the unit arresting members 50 are an interval apart from, and placed in proximity to, the engine-side opposing surface 36 of the engine unit 32 and the transmission-side opposing surface 38 of the transmission unit 34, but the unit-side opposing surfaces 52 are not limited to this. The unit-side opposing surfaces 52 of the unit arresting members 50 may also touch the engine-side opposing surface 36 and the transmission-side opposing surface 38. Furthermore, the unit-side opposing surfaces 52 of the unit arresting members 50 may also be coupled to the engine-side opposing surface 36 and the transmission-side opposing surface 38.

Furthermore, for example, in the above embodiment, the unit arresting members 50 have the same structure on the engine unit 32 side and the transmission unit 34 side and are disposed in substantially the same position in the vehicle front and rear direction, but the unit arresting members 50 are not limited to this. The unit arresting members 50 may also have structures different from each other on the engine unit 32 side and the transmission unit 34 side and may also be disposed in different positions in the vehicle front and rear direction. Furthermore, the unit arresting members 50 may also be disposed on the side members 22 and 24 by a method other than fastening them with bolts. For example, the unit arresting members 50 may also be welded to the side members 22 and 24. Or, the unit arresting members 50 may also be molded integrally with the side members 22 and 24 rather than being separate members.

Furthermore, for example, in the above embodiment, the present invention is applied to a vehicle front portion structure where the engine unit 32 and the transmission unit 34 are adjacent to each other in the vehicle width direction in the engine compartment 16 between the pair of right and left side members 22 and 24 in both side portions in the vehicle width direction of the front portion 12 of the front-engine, front-wheel-drive vehicle 10, but the present invention is not limited to this.

The present invention may also be applied to a vehicle rear portion structure where the engine unit 32 and the transmission unit 34 are adjacent to each other in the vehicle width direction in an engine compartment between a pair of right and left side members in both side portions in the vehicle width direction of a rear portion of a rear-engine, rear-wheel-drive vehicle. Specifically, the present invention may also have a structure where, in the drawings, the vehicle front and rear direction front side (arrow FR) becomes the vehicle front and rear direction rear side. It should be noted that, in the case of a rear-engine, rear-wheel-drive vehicle, the same action and effects as those of the above embodiment are obtained in a case where the vehicle is involved in a rear-end crash with the pole-like crash object P.

Furthermore, for example, in the above embodiment, the drive source is an engine, but the drive source is not limited to this. The drive source may also be an electric motor. In other words, the present invention can be applied to electric automobiles and so-called hybrid vehicles.

Moreover, it goes without saying that the present invention can be implemented in a variety of ways without departing from the spirit thereof.

What is claimed is:

1. A vehicle structure comprising:
a pair of right and left side members that are disposed along a vehicle front and rear direction at both side portions in a vehicle width direction;
a drive source and a transmission that are placed adjacent to each other in the vehicle width direction between the pair of right and left side members;
a drive source-side holder that is disposed at a side member on a drive source side and holds the drive source;
a transmission-side holder that is disposed at a side member on a transmission side and holds the transmission;
a drive source-side projecting portion that is disposed at the side member on the drive source side on a vehicle front and rear direction central side of the drive source-side holder, projects toward a drive source-side opposing surface disposed on a vehicle width direction outer side of the drive source, and has formed on its distal end a projecting portion-side opposing surface that opposes or touches the drive source-side opposing surface; and
a transmission-side projecting portion that is disposed at the side member on the transmission side on the vehicle front and rear direction central side of the transmission-side holder, projects toward a transmission-side opposing surface disposed on the vehicle width direction outer side of the transmission, and has formed on its distal end a projecting portion-side opposing surface that opposes or touches the transmission-side opposing surface.

2. The vehicle structure according to claim 1, wherein a vehicle up and down direction width of the projecting portion-side opposing surfaces of the drive source-side projecting portion and the transmission-side projecting portion is set wider than a vehicle up and down direction width of side surfaces on vehicle width direction inner sides of the side members.
